(19) United States
(12) Patent Application Publication
(10) Pub. No.: US 2026/0160970 A1
(43) Pub. Date: Jun. 11, 2026

(54) Shared, Moveable Robot Unit to Reconfigure and Test Passive Fiber Optic Patch-Panels

(71) Applicant: TELESCENT INC., Irvine, CA (US)

(72) Inventor: Anthony Stephen Kewitsch, Santa Monica, CA (US)

(73) Assignee: TELESCENT INC., Irvine, CA (US)

(21) Appl. No.: 19/037,661

(22) Filed: Jan. 27, 2025

Related U.S. Application Data
(60) Provisional application No. 63/624,934, filed on Jan. 25, 2024.

(51) Int. Cl. G02B 6/46; G02B 6/44

(52) U.S. Cl. CPC G02B 6/46; G02B 6/4446; G02B 6/44528

(57) ABSTRACT

A patch panel system includes a fiber optic patch panel and a separate robot unit designed to interface with the patch panel (e.g., dock with) and to configure, reconfigure, test, validate, or otherwise provision one or more fiber optic connections of the patch panel. The patch panel includes connection ports arranged in an array of rows and columns, with each row being laterally moveable according to a disentanglement algorithm to provide the robot unit with unobstructed access to fiber optic connections.

### RELATED APPLICATIONS

This application claims the benefit of U.S. application No. 63/624,934, filed Jan. 25, 2024, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention generally relates to patch panel assemblies and automated configuration, reconfiguration, testing, validation, inventory, and otherwise provisioning of passive fiber optic patch panels.

### BACKGROUND

Fiber optic patch panels require cabling installation, moves, adds, changes, and testing over a network's lifetime within and between data centers. These tasks are currently performed manually, causing delays, errors, and high costs. It is desirable and an object hereof to automate these tasks using robotic means with performance that matches or exceeds such manual implementations.

However, entanglement of fiber optical cables is challenging for technicians and robots. Such entanglement leads to degradation and breakage of cables, which causes costly network failures.

This entanglement challenge may be overcome by using the Knots, Braids, Strands (KBS) algorithm to physically reconfigure fibers using a robot in a dense, arbitrary cross-connected volume, as disclosed in prior patent applications such as U.S. Pat. No. 8,068,715, the entire contents of which is hereby fully incorporated herein by reference for all purposes. U.S. Pat. No. 8,068,715 discloses highly scalable and modular automated optical cross-connect switch devices with low loss and scalability to high port counts.

### SUMMARY

The present invention is specified in the claims and in the description below. The following summary is exemplary and not limiting. Presently preferred embodiments are particularly specified in the dependent claims and the description of various embodiments.

In some general aspects, a moveable robotic system may be employed to controllably dock with patch panels to automate the reconfiguration, testing, validation, inventory, and other provisioning of internal connections within the patch-panel frames without entangling these internal connections by incorporating the KBS algorithm and control system.

In one general aspect, this invention is a robotic system that can configure, reconfigure, test, inventory, validate, and otherwise provision static fiber optic patch panels.

The robotic system may include a wheeled platform and a telescopic robotic arm with a gripper at the end of the arm on a horizontal translation stage. The robotic system may also include an array of row actuator mechanisms that can precisely shift by a distance increment in a direction parallel to each row.

The robotic system may also include a first interlocking mechanism to precisely align and lock the robotic system to a static fiber optic patch panel. The robotic system may include a second series of interlocking mechanisms to enable each of a multiplicity of row actuator mechanisms to attach to each of a multiplicity of patch-panel rows. The robotic system may also include a controller to move the telescopic robotic and individual row actuator mechanisms in a coordinated fashion.

Implementations may include one or more of the following features, alone or combinations:
The robotic system where movements of the individual row actuator mechanisms are determined by a KBS disentanglement algorithm.
The robotic system where software for the KBS disentanglement algorithm resides on the controller.
The robotic system, where a static fiber optic patch panel has automatic fiber slack management for internal fiber optic cables, and the internal fiber optic cables emanate from a one-dimensional array of backbone tubes.
The robotic system where the static fiber optic patch-panel includes a rack with interlocking elements that the robotic system engages.
The robotic system where the static fiber optic patch panel has 1,000 to 20,000 internal fiber optic cables that can be configured, reconfigured, tested, inventoried, validated, or otherwise provisioned by the robotic system.
The robotic system where the internal fiber optic cables are each transportable by the gripper from any port in the static fiber optic patch panel to any other port in the same static fiber optic patch panel.
The robotic system where the wheeled platform can be moved, positioned, and interlocked to one of several patch panels.
The robotic system where the wheeled platform is a self-propelled mobile robot platform.
The robotic system where the robotic system is battery-powered.
The robotic system where each actuator includes one or more sensing elements in communication with the controller to confirm proper movements of actuators.

In another general aspect, this invention is a static patch-panel system that may include a fixed rack. The static patch-panel system may also include a front plane with a fiber optic connector array having a series of vertically arranged, individual, identical row segments, each row segment containing a spaced-apart series of fiber optic connector receptacles accessible on the outside. The static patch-panel system may also include a multiplicity of internal fiber optic connectors terminating lengths of fiber optic cable plugged into a back side of the fiber optic connector array in the front plane. The static patch-panel system may also include a middle plane in which the lengths of fiber optic cable pass through a substantially one-dimensional array of guides. The static patch-panel system may include a multiplicity of slack management assemblies behind the middle plane to individually tension the lengths of fiber optic cable so that there is no substantial slack between the front and middle planes. The static patch-panel system may also include a mechanism to enable a transportable robot to dock with the rack such that precise alignment of the robot to columns of the connector array is achieved.

Implementations may include one or more of the following features, alone or in combinations:
The robotic system where movements of the individual row actuator mechanisms are determined by a KBS disentanglement algorithm.
The robotic system where software for the KBS disentanglement algorithm resides on the controller.
The robotic system, where a static fiber optic patch panel has automatic fiber slack management for internal fiber optic cables, and the internal fiber optic cables emanate from a one-dimensional array of backbone tubes.
The robotic system where the static fiber optic patch-panel includes a rack with interlocking elements that the robotic system engages.

The robotic system where the static fiber optic patch panel has 1,000 to 20,000 internal fiber optic cables that can be configured, reconfigured, tested, inventoried, validated, or otherwise provisioned by the robotic system.
The robotic system where the internal fiber optic cables are each transportable by the gripper from any port in the static fiber optic patch panel to any other port in the same static fiber optic patch panel.
The robotic system where the wheeled platform can be moved, positioned, and interlocked to one of several patch panels.
The robotic system where the wheeled platform is a self-propelled mobile robot platform.
The robotic system where the robotic system is battery-powered.
The robotic system where each actuator includes one or more sensing elements in communication with the controller to confirm proper movements of actuators.

The static patch-panel system where the transportable robot includes an actuated arm and gripper that can configure, reconfigure, test, validate, inventory, and otherwise provision any of the internal fiber optic connectors at a back side of the fiber optical connector array. The static patch-panel system where the actuated arm and gripper travel vertically in gaps between internal fiber optic connectors. The static patch-panel system where the actuated arm and gripper travel horizontally above the row segments.

The static patch-panel system where the actuated arm and gripper travel up to 2 meters.

The static patch-panel system where the actuated arm can travel down the connector array in a region between the front plane and the middle plane so that the actuated arm and gripper can engage and transport any of the internal fiber optic connectors without entangling its length of fiber optic cable with other lengths of fiber cable terminated in other internal fiber optic connectors and without colliding with other connectors surrounding the arm. The static patch-panel system has over 1,000 fiber optic receptacles arranged in 12 columns at the front plane. The static patch-panel system where the front plane is about 15 cm from the middle plane. The static patch-panel system where the fiber optic connectors are LC, SC, CS, MU, MPO, MTP, SN, MDC, MMC, or EBO-type connectors.

Systems and methods to configure, reconfigure, test, inventory, validate, and otherwise provision nominally passive patch panel assemblies using a shared mobile robot unit with multiple actuation elements coordinated by a disentanglement algorithm are disclosed. Mechanical features of the passive patch-panel assemblies and of the robot unit that enable robotic automation are further disclosed.

According to one aspect, one or more embodiments are provided below for a patch panel configuration, reconfiguration, testing, inventory, validation, and provisioning system including a patch panel assembly including at least two rows of front-side connector ports leading to corresponding back-side connector ports, each one of the at least two rows laterally movable with respect to each other one of the at least two rows, a robot unit separate from the patch panel assembly and moveable into an engagement with the patch panel assembly, the robot unit including a plurality of translation mechanisms with each one of the plurality of translation mechanisms adapted to engage with a corresponding row of the at least two rows, and an actuation arm configured with the robot unit and adapted to extend to and engage with a predetermined back-side connector configured with a predetermined back-side connector port, wherein at least one of the plurality of translation mechanisms causes lateral movement of a corresponding row of the at least two rows to provide an unobstructed path for the actuation arm to extend to the predetermined back-side connector.

Embodiments hereof may include one or more of the following, alone or in combination:
Each row includes a translation member adapted to engage with a corresponding translation mechanism on the robot unit.
The translation member includes a translation pin, and the corresponding translation mechanism includes a hole adapted to receive the translation pin, or the corresponding translation mechanism includes the translation pin, and the translation member includes the hole adapted to receive the translation pin.
The at least one of the plurality of translation mechanisms includes a translation actuator adapted to cause the lateral movement.
Each of the plurality of translation mechanisms includes a unique translation actuator adapted to cause the lateral movement of a corresponding row.
The actuation arm includes a gripping mechanism adapted to grip the predetermined back-side connector.
The gripping mechanism is coupled to a distal end of the actuation arm.
The actuation arm is telescoping.
The at least one of the plurality of translation mechanisms includes a linear stepper.
The at least one of the plurality of translation mechanisms causes the lateral movement as determined by a KBS algorithm.
The lateral movement includes lateral movement to the left or lateral movement to the right.
The back-side connector ports are spaced apart from one another by a connector port spacing, and the lateral movement includes moving the corresponding row of the at least two rows to the right or the left a distance about equal to the connector port spacing.
The lateral movement forms the unobstructed path, including a path width about equal to the connector port spacing.
Each one of the at least two rows comprises a unique connector substrate.
Each one of the at least two rows comprises a unique connector substrate, and each unique connector substrate includes a corresponding translation member.
The robot unit moves autonomously into the engagement with the patch panel assembly.
The predetermined back-side connector is configured with a first of the at least two rows, and the at least two rows includes an upper row above the first of the at least two rows, and the at least one of the plurality of translation mechanisms causes the lateral movement of the upper row.
The lateral movement of the upper row forms the unobstructed path for the actuation arm to extend to the predetermined back-side connector.
When the robot unit is moved into the engagement with the patch panel assembly, the robot unit and the patch panel assembly are releasably locked to one another using interlocking mechanisms.

Below is an example list of aspects of a robotic system. Those will be indicated with the letters “RS.” Whenever such aspects are referred to, this will be done by referring to “RS” aspects.
RS_1. A robotic system to configure, reconfigure, test, inventory, validate, or otherwise provision static fiber optic patch-panels, the robotic system comprising:
   a wheeled platform;
   a telescopic robotic arm with a gripper at an end of the arm on a horizontal translation stage;
   an array of row actuator mechanisms that can precisely shift by a distance increment in a direction parallel to each row;
   a first interlocking mechanism to precisely align and lock the robotic system to a static fiber optic patch panel;
   a second series of interlocking mechanisms to enable each of a multiplicity of row actuator mechanisms to attach to each of a multiplicity of patch-panel rows; and
   a controller to move the telescopic robotic arm and individual row actuator mechanisms in a coordinated fashion.
RS_2. The robotic system of any of the robotic systems RS_1, wherein movements of the individual row actuator mechanisms are determined by a KBS disentanglement algorithm.
RS_3. The robotic system of any of the robotic systems RS_1 to RS_2, wherein software for the KBS disentanglement algorithm resides on the controller.
RS_4. The robotic system of any of the robotic systems RS_1 to RS_3, wherein a static fiber optic patch panel has automatic fiber slack management for internal fiber optic cables and wherein the internal fiber optic cables emanate from a one-dimensional array of backbone tubes.
RS_5. The robotic system of any of the robotic systems RS_1 to RS_4, wherein the static fiber optic patch-panel includes a rack with interlocking elements that the robotic system engages.
RS_6. The robotic system of any of the robotic systems RS_1 to RS_5, wherein the static fiber optic patch panel has 1,000 to 20,000 internal fiber optic cables that can be reconfigured, tested, validated, inventoried, or otherwise provisioned by the robotic system.
RS_7. The robotic system of any of the robotic systems RS_1 to RS_6, wherein the internal fiber optic cables are each transportable by the gripper from any port in the static fiber optic patch-panel to any other port in the same static fiber optic patch-panel.
RS_8. The robotic system of any of the robotic systems RS_1 to RS_7, wherein the wheeled platform can be moved, positioned, and interlocked to one of several patch panels by a technician.
RS_9. The robotic system of any of the robotic systems RS_1 to RS_8, wherein the wheeled platform is a mobile robot platform that is self-propelled.
RS_10. The robotic system of any of the robotic systems RS_1 to RS_9, wherein the robotic system is battery powered.
RS_11. The robotic system of any of the robotic systems RS_1 to RS_10, wherein each actuator includes one or more sensing elements in communication with the controller to confirm proper movements of actuators.

Below are patch-panel system embodiments indicated with the letters “PPS.” Whenever such aspects are referred to, this will be done by referring to “PPS” aspects.
PPS_12. A static patch-panel system for fiber optic interconnects, the system comprises:
   a fixed rack;
a front plane with a fiber optic connector array comprising a series of vertically arranged, individual, identical row segments, each row segment containing a spaced-apart series of fiber optic connector receptacles accessible on the outside;
   a multiplicity of internal fiber optic connectors terminating lengths of fiber optic cable that are plugged into a back side of the fiber optic connector array in the front plane;
   a middle plane in which the lengths of fiber optic cable pass through a substantially one-dimensional array of guides;
   a multiplicity of slack management assemblies behind the middle plane to individually tension the lengths of fiber optic cable so that there is no substantial slack between the front and middle planes; and
   a mechanism to enable a transportable robot to dock with the rack such that precise alignment of the robot to columns of the connector array is achieved.
PPS_13. The static patch-panel system of any one of the patch-panel systems PPS_12, wherein the transportable robot includes an actuated arm and gripper that can reconfigure, test, validate, inventory, or otherwise provision any of the internal fiber optic connectors at a back side of the fiber optical connector array.
PPS_14. The static patch-panel system of any one of the patch-panel systems PPS_12 to PPS_13, wherein the actuated arm and gripper travel vertically in gaps between internal fiber optic connectors.
PPS_15. The static patch-panel system of any one of the patch-panel systems PPS_12 to PPS_14, wherein the actuated arm and gripper travel horizontally above the row segments.
PPS_16. The static patch-panel system of any one of the patch-panel systems PPS_12 to PPS_15, wherein the actuated arm and gripper travel up to 2 meters.
PPS_17. The static patch-panel system of any one of the patch-panel systems PPS_12 to PPS_16, wherein the actuated arm can travel down the connector array in a region between the front plane and the middle plane so that the actuated arm and gripper can engage and transport any of the internal fiber optic connectors without entangling its length of fiber optic cable with other lengths of fiber cable terminated in other internal fiber optic connectors and without colliding with other connectors surrounding the arm.
PPS_18. The static patch-panel system of any one of the patch-panel systems PPS_12 to PPS_17, wherein over 1,000 fiber optic receptacles are arranged in 12 columns at the front plane.
PPS_19. The static patch-panel system of any one of the patch-panel systems PPS_12 to PPS_18, wherein the front plane is about 15 cm from the middle plane.
PPS_20. The static patch-panel system of any one of the patch-panel systems PPS_12 to PPS_19, wherein the fiber optic connectors are LC, SC, CS, MU, MPO, MTP, SN, MDC, MMC, or EBO-type connectors.
PPS_23. a Patch Panel System Comprising:
   a patch panel assembly including at least two rows of front-side connector ports leading to corresponding back-side connector ports, each one of the at least two rows laterally movable with respect to each other one of the at least two rows;
   a robot unit, separate from the patch panel assembly and moveable into an engagement with the patch panel assembly, the robot unit including a plurality of translation mechanisms with each one of the plurality of translation mechanisms adapted to engage with a corresponding row of the at least two rows; and
   an actuation arm configured with the robot unit and adapted to extend to and engage with a predetermined back-side connector configured with a predetermined back-side connector port,
   wherein at least one of the plurality of translation mechanisms causes lateral movement of a corresponding row of the at least two rows to provide an unobstructed path for the actuation arm to extend to the predetermined back-side connector.
PPS_24. The patch panel system of PPS_23, wherein the predetermined back-side connector is configured with a first of the at least two rows and the at least two rows includes an upper row above the first of the at least two rows, and the at least one of the plurality of translation mechanisms causes a lateral movement of the upper row.
PPS_25. The patch panel system of patch-panel system PPS_24 wherein the lateral movement of the upper row forms the unobstructed path for the actuation arm to extend to the predetermined back-side connector.
PPS_26. The patch panel system of any of the patch-panel systems PPS_23 to PPS_25 wherein each row includes a translation member adapted to engage with a corresponding translation mechanism on the robot unit.
PPS_27. The patch panel system of patch-panel system(s) PPS_26 wherein each translation member includes a translation pin, and the corresponding translation mechanism includes a hole adapted to receive the translation pin, or the corresponding translation mechanism includes the translation pin, and the translation member includes the hole adapted to receive the translation pin.
PPS_28. The patch panel system of any of patch-panel systems PPS_26 to PPS_27 wherein each one of the at least two rows comprises a unique connector substrate, and each unique connector substrate includes a corresponding translation member.
PPS_29. The patch panel system of any of the patch-panel systems PPS_23 to PPS_28 wherein the at least one of the plurality of translation mechanisms includes a translation actuator adapted to cause the lateral movement.
PPS_30. The patch panel system of any of the patch-panel systems PPS_29 wherein each of the plurality of translation mechanisms includes a unique translation actuator adapted to cause the lateral movement of a corresponding row.
PPS_31. The patch panel system of any of the patch-panel systems PPS_23 to PPS_30 wherein the actuation arm includes a gripping mechanism adapted to grip the predetermined back-side connector.
PPS_32. The patch panel system of any of the patch-panel systems PPS_31 wherein the gripping mechanism is coupled to a distal end of the actuation arm.
PPS_33. The patch panel system of any of the patch-panel systems PPS_23 to PPS_32 wherein the actuation arm is robotic.
PPS_34. The patch panel system of any of the patch-panel systems PPS_23 to PPS_33 wherein the actuation arm is telescoping.
PPS_35. The patch panel system of any of the patch-panel systems PPS_23 to PPS_34 wherein the at least one of the plurality of translation mechanisms includes a linear stepper.
PPS_36. The patch panel system of any of the patch-panel systems PPS_23 to PPS_35 wherein the at least one of the plurality of translation mechanisms causes the lateral movement as determined by a Knots, Braids, Strands (KBS) algorithm.
PPS_37. The patch panel system of any of the patch-panel systems PPS_23 to PPS_36 wherein the lateral movement includes lateral movement to the left or to the right.
PPS_38. The patch panel system of any of the patch-panel systems PPS_23 to PPS_37 wherein the back-side connector ports are spaced apart from one another by a connector port spacing, and the lateral movement includes moving the corresponding row of the at least two rows to the right or the left a distance about equal to the connector port spacing.
PPS_39. The patch panel system of any of the patch-panel systems PPS_38 to PPS_38 wherein the lateral movement forms the unobstructed path, including a path width about equal to the connector port spacing.
PPS_40. The patch panel system of any of the patch-panel systems PPS_23 to PPS_39, wherein each one of the at least two rows, is comprised of a unique connector substrate.
PPS_41. The patch panel system of any of the patch-panel systems PPS_23 to PPS_40 wherein the robot unit moves autonomously into the engagement with the patch panel assembly.
PPS_42. The patch panel system of any of the patch-panel systems PPS_23 to PPS_41 wherein when the robot unit is moved into the engagement with the patch panel assembly, the robot unit and the patch panel assembly are releasably locked to one another using interlocking mechanisms.

Below are patch-panel system aspects indicated with the letter “S.” Whenever such aspects are referred to, this will be done by referring to “S” aspects.
S_43. A system comprising a plurality of static patch-panel systems according to any of the patch-panel systems PPS_12 to PPS_42; and one or more robotic systems according to any of the robotic systems RS_1 to RS_11.
S_44. A system comprising one or more robotic systems according to any of the robotic systems RS_1 to RS_11; and a plurality of static patch-panel systems according to any of the patch-panel systems PPS_12 to PPS_42.

The above features and additional details of the invention are described further in the examples herein, which are intended to illustrate the invention further but are not intended to limit its scope in any way.

### BRIEF DESCRIPTION OF THE DRAWINGS

Various other objects, features, and attendant advantages of the present invention will become fully appreciated as the same becomes better understood when considered in conjunction with the accompanying drawings, in which like reference characters designate the same or similar parts throughout the several views and wherein:

FIG. 1A shows a side view of a patch panel system in a disengaged arrangement according to embodiments hereof;

FIG. 1B shows a front view of a patch panel system in a disengaged arrangement according to embodiments hereof;

FIG. 1C shows a side view of a patch panel system in an engaged arrangement according to embodiments hereof;

FIG. 1D shows a front view of a patch panel system in an engaged arrangement according to embodiments hereof;

FIG. 1E shows a side view of a patch panel system in an engaged arrangement according to embodiments hereof;

FIG. 1F shows a front view of a patch panel system in an engaged arrangement according to embodiments hereof;

FIGS. 2A and 2B show front views of rows of connector substrates according to embodiments hereof;

FIG. 3A shows a top view of a connector substrate separated from a lateral movement mechanism according to embodiments hereof;

FIG. 3B shows a top view of a connector substrate engaged with a lateral movement mechanism according to embodiments hereof;

FIGS. 4A to 4C show top views of a connector substrate engaged with a lateral movement mechanism according to embodiments hereof;

FIG. 5A shows a front view of a patch panel system in a disengage arrangement according to embodiments hereof; and

FIG. 5B shows a front view of a patch panel system in a disengaged arrangement according to embodiments hereof;

FIGS. 6A and 6B are flow charts depicting the operation of aspects hereof.

### DETAILED DESCRIPTION

Patch panel systems and methods are provided. The patch panel system may include a fiber optic patch panel and a separate robot unit designed to interface with the patch panel (e.g., dock with) and to reconfigure, test, validate, inventory, or otherwise provision one or more fiber optic connections of the patch panel. The patch panel may include connection ports arranged in an array of rows and columns. The robot unit may be designed to mechanically reconfigure, test, inventory, validate, and otherwise provision any connectors within any one of the connection ports within the array as desired.

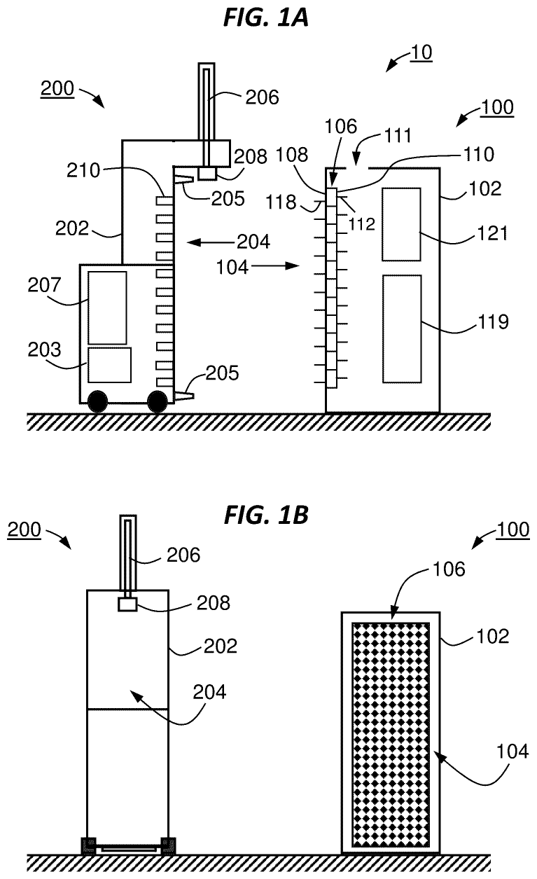

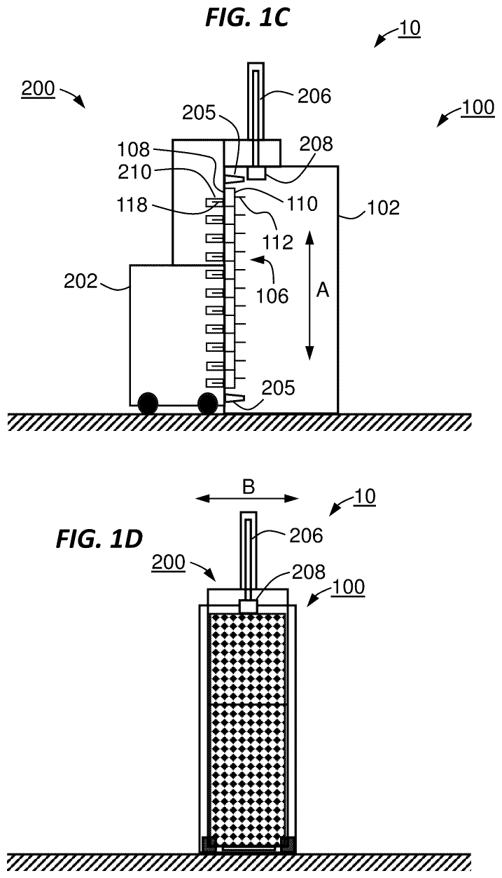

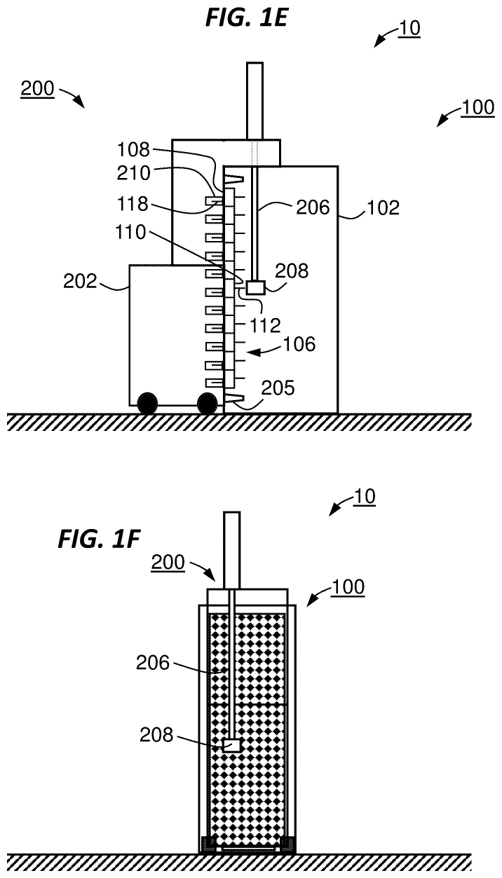

FIG. 1A shows a side view of a patch panel system 10, including patch panel assembly 100 and a robot unit 200 in an opposing arrangement and generally disengaged, and FIG. 1B shows a front view of the patch panel 100 and the robot unit 200 side-by-side.

As shown in FIGS. 1A and 1B, the patch panel assembly 100 may include a housing 102 (or frame or rack) with a front side 104 and a connector array 106. The connector array 106 may include front-side connector ports 108 (preferably accessible from the front 104 of the housing 102) leading to (and optically or electrically connected to) back-side connector ports 110 within the patch panel assembly 100. The front-side connector ports 108 may receive connections (e.g., optical fibers) from external equipment, and the back-side connector ports 110 may receive back-side connectors 112 configured with optical fibers that extend into an interior backbone within the patch panel assembly 100 to be made available at the patch panel assembly's output. The patch panel assembly 100 may be passive, unpowered, and nominally static in some embodiments.

As described herein, each back-side connector 112 configured with a corresponding back-side connector port 110 may be controllably reconfigured, e.g., moved from a first back-side connector port 110-1 to a second back-side connector port 110-2. This way, the optical path from the front-side connector ports 108 to the output of the patch panel assembly 100 may be effectively reconfigured, tested, inventoried, validated, and/or otherwise provisioned as desired.

In some embodiments, the patch panel assembly 100 may include an upper port 111 or opening in its housing 102 (e.g., on its top side) through which elements of the robot unit 200 may enter into the inner volume of the patch panel assembly 100. For example, the robot unit's actuation arm 206 and associated gripping mechanism 208 may enter through the upper port 111 to gain access to the backside connector ports 110 and connectors 112 for reconfiguration, testing, inventorying, validation, and/or otherwise provisioning as described in other sections. The upper port 111 may be opened for use and closed when not needed or remain open at all times.

In some embodiments, each row of connector ports 108, 110 within the connector array 106 may be self-contained and independently moveable from side to side with respect to the other rows. As such, as shown in FIG. 1A, each row may include translation members 118 that may be gripped (e.g., by the robot unit 200) to implement lateral movement. This lateral movement may enable the robot unit 200 to access particular back-side connectors 112 that may otherwise be obstructed (e.g., by other back-side connectors 112 and optical fibers extending therefrom). This will be described in detail elsewhere herein.

In some embodiments, the patch panel assembly 100 also includes a passive slack management system 119 including a multiplicity of splice trays 121 and spring-loaded fiber optic cable tensioning reels and/or pulleys such as those disclosed in U.S. Pat. Nos. 8,488,938 and 10,345,526, the entire contents of both of which are hereby fully incorporated herein by reference for all purposes. Typical patch-panel frames may be up to 2.5 m tall, less than 1.0 m deep, and about 1.0 m wide and may contain 100 to 5,000 fiber optic connector ports. Connector ports may include any of the various industry standard types, including LC, MU, SC, SN, MDC, MPO, MTP, expanded beam, etc. Individual or bundles of single-mode or multimode fiber are terminated in the internal or back side of the connector port array. The patch panel assembly 100 may include other elements as described herein and/or as known in the art as necessary to fulfill its functionalities.

As shown, e.g., in FIGS. 1A and 1B, the robot unit 200 may include a body 202 with a front side 204 designed to generally engage with the front side or front 104 of the patch panel 100. In some embodiments, the robot unit 200 may be considered robotic and may include wheels or other movement mechanisms so that the unit 200 may be easily moved to a patch panel assembly 100 for docking. The robot unit 200 may include a motor and control, sensing, and power such that it may be self-propelling, self-directing, and self-docking. The robot unit 200 may be autonomous, semi-autonomous, remote-controlled, preprogrammed, manual, and/or semi-manual. As such, the robot unit 200 may move itself into position to engage with a particular patch panel assembly 100 and/or be manually moved, e.g., by a technician. The robot unit 200 may include a controller 203 on which the KBS algorithm may reside and run, and a power source 207 (e.g., a rechargeable battery). The KBS algorithm may also reside on a remote physical or virtual server or another controller. Although described and shown on wheels, in some cases, the robot unit 200 may move on tracks or rails.

In some cases, the patch panel assemblies may be configured or positioned with an optical guidance system wherein a camera on the unit 200 may detect guidance lines on the floor and/or other visual navigation indications so that the robot unit 200 may automatically and autonomously position itself relative to a particular patch panel assembly 100. In some cases, the robot unit 200 may operate autonomously or semi-autonomously and may be under the control of a remote operator. The remote operator may control aspects of the positioning of the robot unit 200 relative to a particular patch panel assembly 100. Indicia such as bar codes and other patterns may be located on the patch panel assembly 100 to assist with the automatic or autonomous docking of the robot unit 200. A camera on the robot unit 200 may use such indicia to position the robot unit 200 with respect to the patch panel assembly 100.

The robot unit 200 may include a communications module that enables the unit 200 to communicate with other systems (e.g., to receive programming or instructions) via wireless technologies such as Wi-Fi or cellular, LAN, WAN, Internet, satellite, and/or other communication protocols.

In some embodiments, the robot unit 200 may position itself (or otherwise be positioned) facing the front 104 of the patch panel assembly 100 (as shown in FIG. 1A) and then move into engagement with the patch panel assembly 100 (as shown in FIG. 1C). The robot unit 200 may include alignment and locking mechanisms 205 (e.g., alignment pins, magnetic latches, etc.) for precise positioning and releasable engagement of unit 200 to the patch panel assembly 100 (e.g., to the patch panels housing 102 or frame). This may include tapered alignment pins and/or kinematic mounts for precise alignment and interlocking of the robot unit 200 to the patch panel assembly 100.

FIG. 1C shows a side view of the robot unit's front side 204 engaged with the front side 104 of the patch panel 100 and FIG. 1D shows a front view of the same. Note that the leading walls of the patch panel assembly 100 and the robot unit 200 have been made transparent in the drawings in FIGS. 1A to 1F to show the elements within and/or behind.

As mentioned, each self-contained row of front-side and back-side connector ports 108, 110 may include translation members 118 to implement lateral movement of the row, and the robot unit 200 may include corresponding lateral movement mechanisms that may engage the translation members 118 to implement the lateral movement. This also may provide physical support and alignment to each self-contained row of connector ports 108, 110 during use.

The robot unit 200 may also include an actuation arm 206, which includes a gripping mechanism 208, e.g., configured at its distal end. The actuation arm 206 may be telescoping and/or may employ other elongation or translation techniques. As described herein, the actuation arm 206 and its gripping mechanism 208 may be extended into the patch panel's connector array 106 (e.g., at the back side) to engage and reconfigure, test, inventory, validate, and/or otherwise provision one or more back-side connectors 112 within the patch panel's array of back-side connector ports 110.

For ease of understanding, the movement of the actuation arm 206 and its gripping mechanism 208 will first be described without describing the lateral movement of the individual rows of front-side and back-side connector ports 108, 110. After this initial description, the lateral movement and the reasons for the lateral movement will be described.

In some embodiments, e.g., as shown in FIGS. 1C to 1F, with the robot unit 200 engaged with the patch panel assembly 100, the actuation arm 206 and its gripping mechanism 208 may be controllably moved to engage a particular back-side connector 110 within a particular back-side connection port 110. For example, in some embodiments, the actuator arm 206 and the gripping mechanism 208 may be moved up and/or down in the direction of the arrow A in FIG. 1C and/or side-to-side in the direction of the arrow B in FIG. 1D. This may result in an example configuration as shown, e.g., in FIGS. 1E to 1F, with FIG. 1E showing the actuation arm 206 and its gripping mechanism 208 moved downward, and FIG. 1F showing the actuation arm 206 and its gripping mechanism 208 moved laterally (to the left in the drawing). This may enable the gripping mechanism 208 to be aligned with a particular pluggable connector 112 within a particular back-side connection port 110 at a particular location in the connector array 106. Once aligned, the actuation arm 206 and the gripping mechanism 208 may unplug the connector 112 from within the back-side connector port 110, and then move it to and plug it into a different connector port 110 at a different location. In this way, the optical path from the input to the patch panel 100 to the output of the patch panel assembly 100 may be reconfigured, tested, inventoried, validated, and/or otherwise provisioned. It is understood that the example provided above is for demonstration and that the particular connector 112 may be moved to other positions and/or locations.

The lateral movement of the individual rows of front-side and back-side connector ports 108 and 110 will be described next.

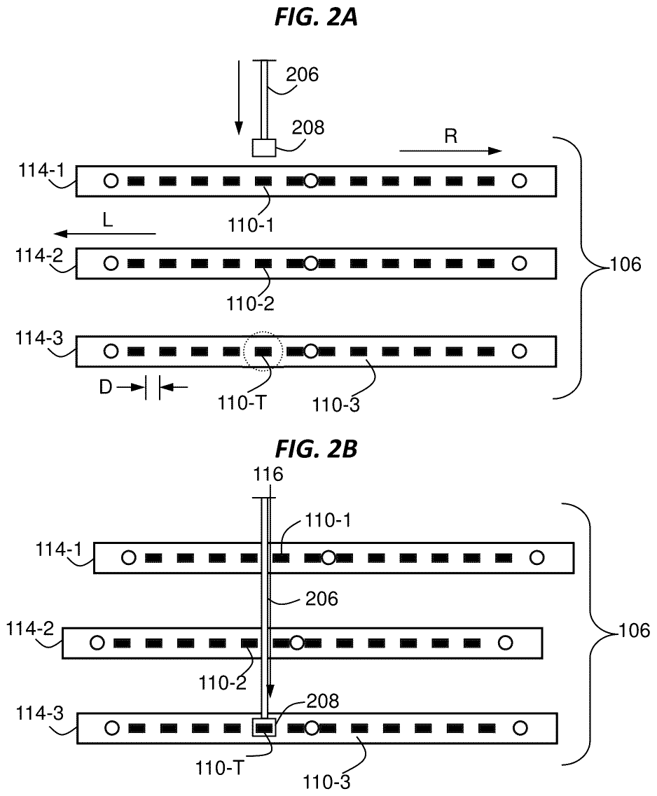

In some embodiments, each row of corresponding front-side and back-side connectors 108 and 110 within the connector array 106 may be mounted on a shared connection substrate 114. For example, FIG. 2A depicts an array 106 including three connection substrates 114-1, 114-2, 114-3 (collectively, “connection substrate 114”) with each substrate 114 including twelve connector ports 110 (110-1, 110-2, 110-3, collectively, “connector ports 110”). Note that the arrangement shown in FIG. 2A is for demonstration, and the array 106 may include any number of connection substrates 114 with any number of connector ports 110. For example, a typical array 106 may include 12 to 200 rows and 10 to 24 columns of connectors 108, 110, with each row comprising an individual connection substrate 114. Each substrate 114 may be about 8 mm to 12 mm tall and about 50 cm wide and may comprise aluminum, steel, plastic, and/or other suitable materials.

As shown in FIG. 2A, if it is desired for the actuation arm 206 to be positioned (e.g., lowered) to engage the target connector port 110-T (circled in the bottom row 114-3), its path may be obstructed by other connector ports 110 and associated connectors 112 (and the fibers connected thereto) in-line and directly above the target connector port 110-T. As such, this may prevent the actuation arm 206 from being properly positioned.

To solve this problem, each connection substrate 114 may be laterally moveable from side to side, e.g., from left to right. In some embodiments, the back-side connectors 110 may be laterally spaced apart from one another on each substrate 114 by a spacing D (e.g., about 25 mm to 35 mm). It may be preferable that the spacing D be uniform between each connector 110 across the substrate 114 and from substrate 114-1 to substrate 114-3. In some embodiments, the substrates 114 above the target connector port 110-T may each be shifted to the left or the right, with the substrate 114-3 containing the target connector port 110-T set in a center position. This may form a pathway or access channel 116 directly above the target connector 110-T, through which the actuation arm 206 may travel to gain access to the target connector 110-T for engagement.

For example, as shown in FIG. 2A, the top substrate 114 may be shifted to the right in the direction of the arrow R, and the middle substrate 114 may be shifted to the left in the direction of the arrow L. This may form the access channel 116 (e.g., a narrow columnar gap) directly above the target connection port 110-T for the actuation arm 206 to pass. As such, the actuation arm 206 may no longer be obstructed from the target connection port 110-T, as shown in FIG. 2B.

Although the description and explanation are given here for three substrates (114-1, 114-2, 114-3), with two substrates being moved laterally, those skilled in the art will realize, upon reading this description, that more than two substrates may need to be moved laterally to provide unobstructed access to the target connection port by the actuation arm 206.

In some embodiments, it may be preferable that each substrate 114 above the target connection port 110′ be moved laterally (e.g., to the left or right) a distance about equal to the spacing D between adjacent connector ports 110. In this way, the width of the access channel 116 may be maximized (e.g., it may generally have a width of D). The gripping mechanism 208 has a narrow form factor (less than D), e.g., less than about 20 mm in width, so that it may easily fit within the channel 116. It is understood that the example provided above is meant for demonstration and that different substrates 114 may be moved in different directions and/or distances depending, e.g., on the reconfiguration or provisioning goals. In general, the connector substrates 114 may be moved to a left position, a right position, and/or to a center position, with the substrate 114, including the target connector 110-T being placed into the center position and the substrates 114 above the target connector 110′ being placed in either the left or right positions as determined, e.g., by the KBS algorithm defining the shuffle pattern of substrates 114 and the motion of actuation arm 206 and the gripping mechanism 208.

In some embodiments, the robot unit 200 is designed to implement the lateral movement of each individual substrate 114 to form each access channel 116 as described above. As such, the robot unit 200 may include a lateral movement mechanism 210 dedicated to each individual connector substrate 114. That is, each individual lateral movement mechanism 210 may be configured to move a corresponding individual connector substrate 114 independent of the other connector substrates 114.

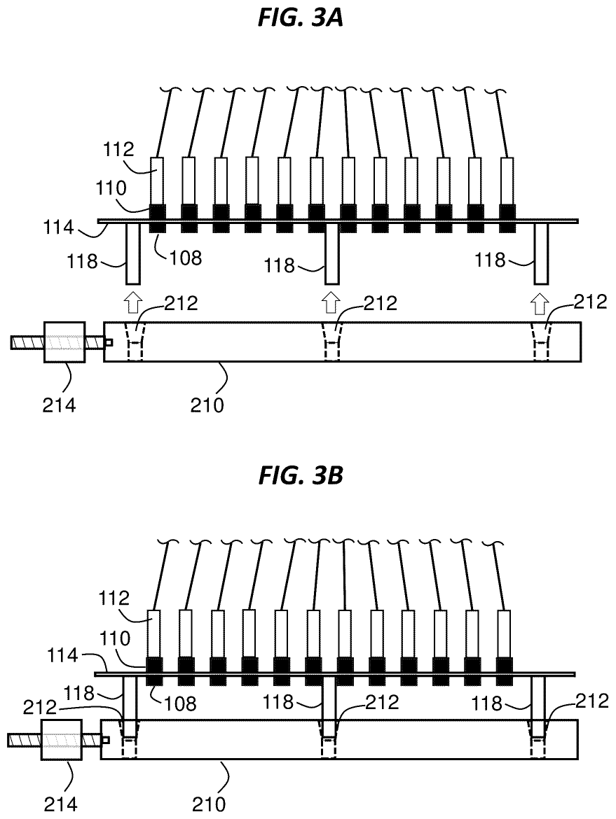

FIG. 3A shows a top view of an individual connector substrate 114 with optical fibers extending from back-side connectors 112 and into an interior backbone within the patch panel assembly 100. FIG. 3A also shows a lateral movement mechanism 210 (e.g., as part of the robot unit 200) aligned with and facing the front of the substrate 114. FIG. 3B shows the connection substrate 114 engaged with and releasably attached to the lateral movement mechanisms 210.

In some embodiments, as shown in FIGS. 3A-3B, each connector substrate 114 may include one or more translation members or pins 118, and each corresponding lateral movement mechanism 210 (of the robot unit 200) may include corresponding receiving ports 212 designed to engage with a corresponding translation member or pins 118. For example, as shown, each substrate 114 may include one or more (e.g., three) translation pins 118 extending outward from the substrate 114, and the lateral movement mechanism 210 may include corresponding receiving ports 212 that may register with and releasably engage with the corresponding translation pins 118. Once engaged, the robot unit's lateral movement mechanism 210 may implement the lateral movement of the connector substrate 114, e.g., as determined by the KBS algorithm.

While FIGS. 3A-3B depict the attachment members 118 as pins being received into corresponding receiving ports 212 on the lateral movement mechanism 210; it is understood that other attachment techniques may also be employed. For example, the translation members 118 may include receiving ports, and the lateral movement mechanism 210 may include pins that are received into the receiving ports. Other attachment mechanisms such as, without limitation, notches, detents, latches, clips, hooks, other attachment mechanisms, and/or any combinations thereof also may be used. In addition, each connector substrate 114 may be implemented with sliding mechanisms (e.g., slide rails or guides configured with the housing 102 or frame of the patch panel assembly 100) and low friction bearings to provide precise and smooth movement of the substrates 114. The lateral movement mechanism 210 and/or the patch panel 100 may include optical sensors, microswitches, or other elements to measure and establish precise positioning of the individual connector substrates 114 with respect to one another and to the actuation arm 206 and gripping mechanism 208. In this way, a precise access channel 116 may be formed through which the actuation arm 206 and gripping mechanism 208 may pass without interfering with adjacent back-side connectors 112 and fibers.

In some embodiments, the lateral movement mechanism 210 may include a translation actuator 214 (preferably linear) configured with each lateral movement mechanism 210 to provide controlled movement of the lateral movement mechanism 210 and to the connector substrate 114 attached thereto. The translation actuator 214 may include a linear stepper motor or other suitable lateral actuator that may preferably provide precise and low friction translation of each corresponding connector substrate 114. It is understood that any suitable linear translation actuator 214 may be utilized.

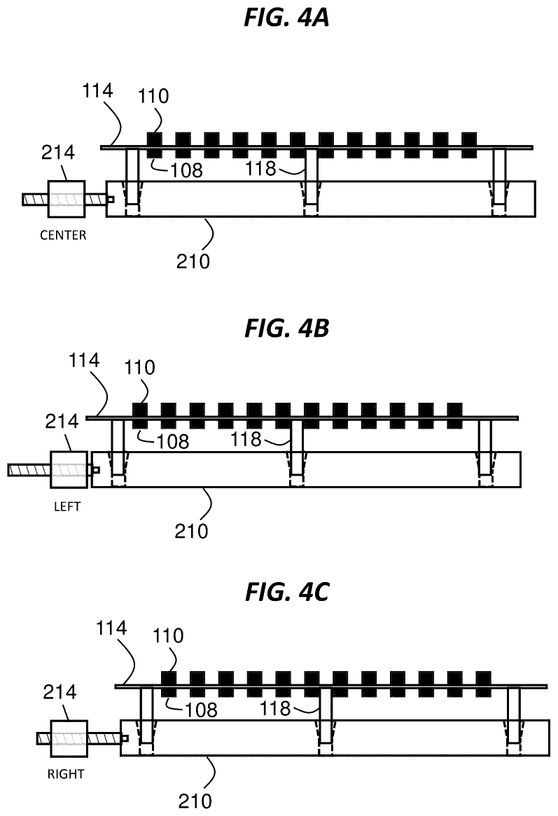

FIGS. 4A, 4B, and 4C show a linear translation mechanism 210 engaged with a connector substrate 114, with FIG. 4A showing the connector substrate 114 placed in a center position, FIG. 4B showing the connector substrate 114 moved to a left position, and FIG. 4C showing the connector substrate 114 moved to a right position.

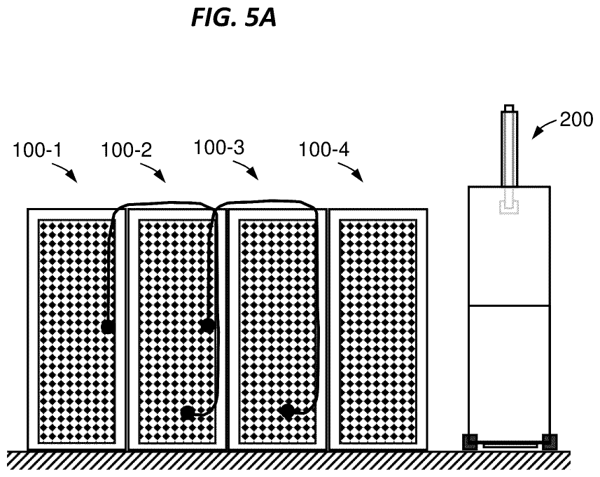

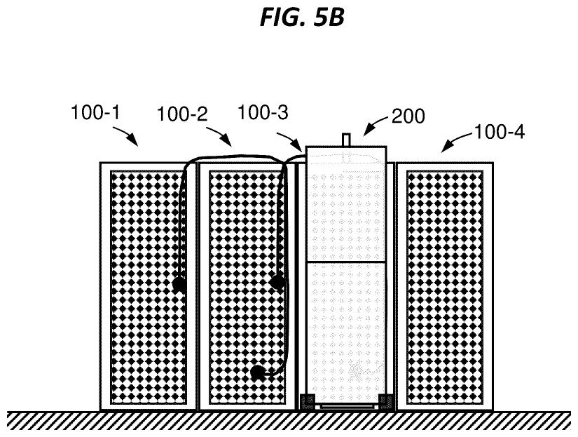

FIG. 5A illustrates multiple patch panel assemblies 100-1, 100-2, 100-3, 100-4 (collectively 100), with front side cables (C1, C2) plugged into front-side connector ports 108, with the robot unit 200 positioned disengaged from any of the patch panel assemblies 100 (e.g., in a standby mode). The front-side cables are dressed along the front 104 of the patch-panel assemblies 100 so that robot unit 200 may gain access to the back-side connector ports 110 without disturbing or disrupting data transmission over the cables. The front side cables preferably have sufficient slack so the corresponding connector substrates 114 (that make up the rows of connectors 110) can move left, right, and center without putting excessive strain or bending on the front side cables.

FIG. 5B illustrates the robot unit 200 selectively engaged with patch-panel assembly 100-3 of FIG. 5A to drive the reconfiguration, testing, inventorying, validation, and/or otherwise provisioning of fiber interconnects within the patch-panel assembly 100. The mobile robot unit 200 can operate (e.g., perform reconfiguration, testing, inventorying, validation, or other provisioning) on a first bay, then, upon completion, move to a second bay to perform reconfigurations, etc. This way, the cost of a single robot unit 200 can be amortized over a larger number of cables to provide a cost-effective automation solution.

An operational advantage of this robotic patch-panel system is that the system can be installed using standard data center cabling operating procedures. The process of installing fiber on the static patch-panel frames includes the steps below:
The equipment is terminated to the patch-panel assemblies(s) 100, e.g., to the front, back, and/or both the front and back sides.
The patch panel assemblies 100 are cabled using standard operating procedures.

Once this cabling is installed (e.g., manually), the moveable robot unit 200 may perform all testing, validation, inventory, reconfiguration, and other provisioning by docking to a selected patch panel assembly 100 without human intervention. The ability for one robot unit 200 to operate on (e.g., reconfigure, test, inventory, validate, and/or otherwise provision) multiple patch panel assemblies 100 has significant cost benefits. In addition, multiple robot units 200 may be deployed for redundancy or to facilitate parallel reconfiguration, etc., of interconnects.

It is understood that any aspect or element of any embodiment of the patch panel system 10 may be combined with any aspect or element of any other embodiment of the patch panel system 10 to form additional embodiments of the panel system 10, all of which are within the scope of the system 10.

### EXAMPLE OPERATION

### Example 1

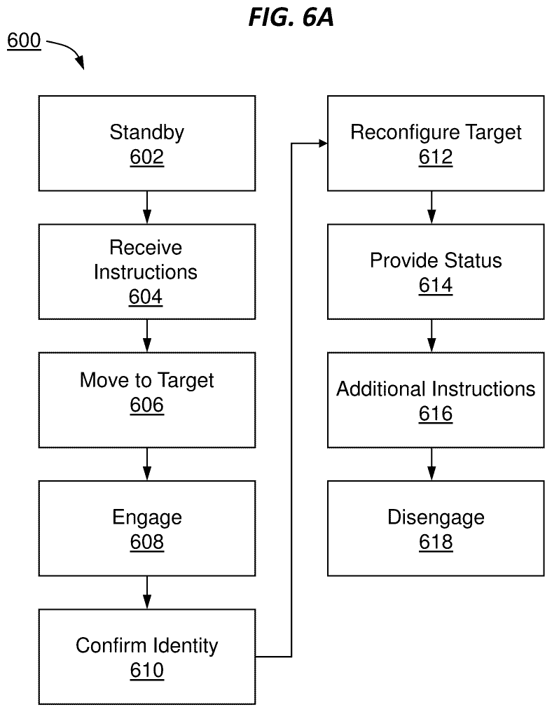

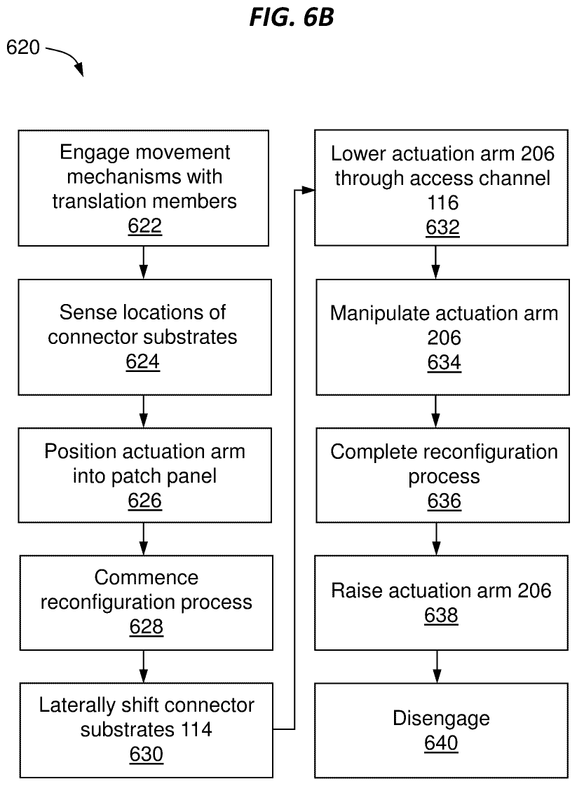

FIG. 6A shows actions 600 that a robot unit 200 and/or patch panel assembly 100 may take while operating, as described herein.

The robot unit 200 may be in standby mode (at 602), e.g., as shown in FIG. 5A.

The robot unit 200 receives instructions (at 604) to reconfigure, test, inventory, validate, and/or otherwise provision a particular target patch panel assembly 100 (e.g., patch panel assembly 100-3 in FIGS. 5A-5B). The robot unit 200 moves (or is moved) to the target patch panel assembly (at 606). A technician may move the robot unit 200, or it may move or be moved autonomously or semi-autonomously to the target patch panel assembly.

The robot unit 200 then engages with the target patch panel assembly (at 608). Engagement may include checking the identity of the patch panel assembly engaging alignment and/or locking mechanisms on the robot unit 200 (e.g., its alignment pins 205) with corresponding alignment and/or locking mechanisms on the target patch panel assembly. This way, the robot unit 200 may be precisely aligned, registered, and engaged with the target patch panel assembly 100.

Once engaged, the robot unit 200 may confirm the identity of the target patch panel assembly 100 (at 610). The pre-engagement identity checks may rely on indicia (e.g., bar codes or RFID tags) on the target patch panel. Post-engagement identity confirmation may use an electronic signature and identity information obtained by the robot unit 200 from the target patch panel to which it is connected.

The post-engagement identity confirmation may include the robot unit 200 electronically querying the patch panel assembly 100 via wireless communications and/or through an electronic connection, e.g., through the alignment and/or locking mechanisms and/or by other queries.

Once the identity of the patch panel assembly 100 is confirmed and the robot unit 200 and the patch panel assembly 100 are fully engaged, the robot unit 200 may perform the instructed procedure (e.g., reconfiguration, testing, inventorying, validation, and/or otherwise provisioning) on the target patch panel assembly 100 (at 612).

During or after the process (at 612) is completed, the robot unit 200 may provide (at 614) a status report to a user (e.g., a network manager), including, e.g., whether the process was a success, whether problems were encountered, associated error codes, etc.).

Depending on the outcome of the process, the robot unit 200 may (at 616) receive or otherwise access additional instructions (e.g., troubleshooting instructions) to operate on the target patch panel assembly 100 further. While performing these additional instructions, the robot unit 200 may continue to update the network manager.

Ultimately, the robot unit 200 may terminate the process (e.g., upon the success of the reconfiguration, upon successfully troubleshooting the patch panel assembly 100, upon determining a hardware failure within the patch panel assembly 100, etc.), the robot unit 200 may disengage (at 620) from the target patch panel assembly 100. The robot unit 200 may then, at 622, move to another patch panel assembly 100 if instructed to do so or return to its standby position (e.g., at a docking station).

### Example 2

FIG. 6B shows actions 620 that a patch panel assembly 100 and a robot unit 200 may take while operating, as described herein.

During its engagement with the target patch panel assembly 100, the robot unit 200 may engage (at 622) its lateral movement mechanisms 210 with corresponding translation members 118 on the patch panel's connector substrates 114. Each lateral movement mechanism 210 may mate with a corresponding connector substrate 114 via the translation members 118 on the connector substrate 114. In this way, each lateral movement mechanism 210 on the robot unit 200 may be configured to move its mated connector substrate 114 laterally to the left or the right independent of each other connector substrates 114 mated with the other lateral movement mechanism(s) 210.

In addition (at 624), the robot unit 200 may also sense (e.g., mechanically or optically) the precise location of each individual connector substrate 114 with respect to each other connector substrate 114 and with respect to the robot unit's actuation arm 206 and gripping mechanism 208.

Once engaged, the robot unit 200 may (at 626) lower its actuation arm 206 and gripping mechanism 208 through the patch panel assembly's upper port 111 and into the internal volume of the patch panel assembly 100 above the back-side connector ports 110.

The robot unit 200 may commence a process (e.g., reconfiguration, testing, inventorying, validation, and/or otherwise provisioning) (at 628). To begin (at 630), the robot unit 200 may laterally shift one or more individual patch panel connector substrates 114 per the disentanglement algorithm as described herein (e.g., per the Knots, Braids, Strands (KBS) algorithm) to form a first access channel 116 through which the actuation arm 206 and gripping mechanism 208 may pass. The robot unit 200 may (at 632) lower its actuation arm 206 and gripping mechanism 208 through the first access channel 116 to access a particular back-side connector 112 within a particular back-side connector port 110. The robot unit 200 may (at 634) further manipulate its actuation arm 206 and gripping mechanism 208 to unplug and/or re-plug back-side connectors 112 within back-side connector ports 110 while continuing to laterally shuffle particular connector substrates 114 to form additional access channels 116 as determined by the entanglement algorithm.

The robot unit 200 may (at 636) complete the process, and (at 638) the robot unit 200 may raise its actuation arm 206 and gripping mechanism 208 from within the patch panel assembly 100. The robot unit 200 may (at 640) disengage from the patch panel assembly 100 to await further instructions.

### DISCUSSION

The robotic system described herein introduces cost savings by enabling a single robot to manage multiple fiber optic patch-panel bays. This robotic system is a mobile, shared resource capable of autonomously reconfiguring, testing, validating, inventorying, and otherwise provisioning multiple patch-panel bays within a data center.

Although the description refers to reconfiguring, testing, inventorying, validating, and/or otherwise provisioning, it should be appreciated that a reconfiguration may require testing, inventorying, and validation. However, some operations, e.g., inventorying, may not require reconfiguration. Provisioning may include operations required or useful by the system. Reconfiguration may include, e.g., moving or switching an internal connection within a static fiber optic patch panel.

The robot can move between patch-panel bays, docking with each bay as needed to perform reconfiguration, testing, inventory, validations, and other provisioning. Once a task is completed in one bay, the robot can quickly undock and reposition itself to another bay, minimizing downtime and ensuring continuous operations. This shared-use model eliminates the need for multiple robots or extensive manual labor, providing a cost-effective solution for large-scale data center operations.

By deploying a single robot to serve multiple patch-panel bays, data centers can achieve substantial capital expenditure savings while benefiting from reduced maintenance costs and increased operational efficiency. This approach enhances the return on investment (ROI) for robotic automation. It ensures the system remains adaptable to evolving network demands, making it an ideal solution for modern, high-density data centers.

### CONCLUSION

As used herein, including in the claims, singular forms of terms are to be construed as also including the plural form and vice versa unless the context indicates otherwise. Thus, it should be noted that as used herein, the singular forms “a,” “an,” and “the” include plural references unless the context clearly dictates otherwise.

Throughout the description and claims, the terms “comprise,” “including,” “having,” and “contain” and their variations should be understood as meaning “including but not limited to” and are not intended to exclude other components unless expressly so stated.

It will be appreciated that variations to the embodiments of the invention can be made while still falling within the scope of the invention. Alternative features serving the same, equivalent, or similar purpose can replace features disclosed in the specification, unless stated otherwise. Thus, unless stated otherwise, each feature disclosed represents one example of a generic series of equivalent or similar features.

The present invention also covers the exact terms, features, values, and ranges, etc., in case these terms, features, values, and ranges, etc. are used in conjunction with terms such as “about,” “around,” “generally,” “substantially,” “essentially,” “at least,” etc. (i.e., “about 3” shall also cover exactly 3 or “substantially constant” shall also cover exactly constant).

Those of ordinary skill in the art will realize and appreciate, upon reading this description, that the term “substantially identical length” means the same length, within ±10%, preferably within ±5%. Similarly, as used herein, the term “substantially straight” means “straight,” within ±10%, preferably within ±5%, and the term “substantially equidistant” (or “substantially equal distance”) means “equidistant” within ±10%, preferably within ±5%; and “without substantially bending” means “without bending more than 10%, preferably without bending more than 5%. Thus, in general, as used herein, including in the claims, the term “substantially” when applied to a property (e.g., length, straightness, equality, distance, shape, etc.) means within 10 percent, and preferably within 5 percent of that property.

Use of language, such as “for instance,” “such as,” “for example” (“e.g.,”), and the like, is merely intended to illustrate the invention better and does not indicate a limitation on the scope of the invention unless specifically so claimed.

While the invention has been described in connection with what is presently considered to be the most practical and preferred embodiments, it is to be understood that the invention is not to be limited to the disclosed embodiments but, on the contrary, is intended to cover various modifications and equivalent arrangements included within the spirit and scope of the appended claims.

What is claimed:

1. A robotic system for use with static fiber optic patch-panels, the robotic system comprising:
a wheeled platform;
a telescopic robotic arm with a gripper at an end of an arm on a horizontal translation stage;
an array of row actuator mechanisms that can precisely shift by a distance increment in a direction parallel to each row;
a first interlocking mechanism to precisely align and lock the robotic system to a static fiber optic patch panel;
a second series of interlocking mechanisms to enable each of a multiplicity of row actuator mechanisms to attach to each of a multiplicity of patch-panel rows; and
a controller to move the telescopic robotic arm and individual row actuator mechanisms in a coordinated fashion.

2. The robotic system of claim 1, wherein movements of the individual row actuator mechanisms are determined by a KBS disentanglement algorithm.

3. The robotic system of claim 2, wherein software for the KBS disentanglement algorithm resides on the controller.

4. The robotic system of claim 1, wherein a static fiber optic patch panel has automatic fiber slack management for internal fiber optic cables and wherein the internal fiber optic cables emanate from a one-dimensional array of backbone tubes.

5. The robotic system of claim 4, wherein the static fiber optic patch panel includes a rack with interlocking elements that the robotic system engages.

6. The robotic system of claim 4, wherein the static fiber optic patch panel has 1,000 to 20,000 internal fiber optic cables that can be reconfigured, tested, validated, inventoried, or otherwise provisioned by the robotic system.

7. The robotic system of claim 4, wherein the internal fiber optic cables are each transportable by the gripper from any port in the static fiber optic patch panel to any other port in the same static fiber optic patch panel.

8. The robotic system of claim 1, wherein the wheeled platform can be moved, positioned, and interlocked to one of several patch panels by a technician.

9. The robotic system of claim 1, wherein the wheeled platform is a mobile robot platform that is self-propelled.

10. The robotic system of claim 1, wherein the robotic system is battery-powered.

11. The robotic system of claim 1, wherein each actuator includes one or more sensing elements in communication with the controller to confirm proper movements of actuators.

12. A static patch-panel system for fiber optic interconnects, the system comprising:
a fixed rack;
a front plane with a fiber optic connector array comprising a series of vertically arranged, individual, identical row segments, each row segment containing a spaced-apart series of fiber optic connector receptacles accessible on the outside;
a multiplicity of internal fiber optic connectors terminating lengths of fiber optic cable that are plugged into a back side of the fiber optic connector array in the front plane;
a middle plane in which the lengths of fiber optic cable pass through a substantially one-dimensional array of guides;
a multiplicity of slack management assemblies behind the middle plane to individually tension the lengths of fiber optic cable so that there is no substantial slack between the front plane and the middle plane; and
a mechanism to enable a transportable robot to dock with the rack such that precise alignment of the robot to columns of the connector array is achieved.

13. The static patch-panel system of claim 12, wherein the transportable robot includes an actuated arm and gripper that can reconfigure, test, validate, inventory, or otherwise provision any of the internal fiber optic connectors at a back side of the fiber optical connector array.

14. The static patch-panel system of claim 13, wherein the actuated arm and gripper travel vertically in gaps between internal fiber optic connectors.

15. The static patch-panel system of claim 13, wherein the actuated arm and gripper travel horizontally above the row segments.

16. The static patch-panel system of claim 13, wherein the actuated arm and gripper travel up to 2 meters.

17. The static patch-panel system of claim 13, wherein the actuated arm can travel down the connector array in a region between the front plane and the middle plane so that the actuated arm and gripper can engage and transport any of the internal fiber optic connectors without entangling its length of fiber optic cable with other lengths of fiber cable terminated in other internal fiber optic connectors and without colliding with other connectors surrounding the arm.

18. The static patch-panel system of claim 12, wherein over 1,000 fiber optic receptacles are arranged in 12 columns at the front plane.

19. The static patch-panel system of claim 12, wherein the front plane is about 15 cm from the middle plane.

20. The static patch-panel system of claim 12, wherein the fiber optic connectors are LC, SC, CS, MU, MPO, MTP, SN, MDC, MMC or EBO-type connectors.
